(19) United States
(12) Patent Application Publication
(10) Pub. No.: US 2004/0027467 A1
(43) Pub. Date: Feb. 12, 2004

(54) Digital video camera

(75) Inventor: Hideaki Shiga, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/614,044

(22) Filed: Jul. 8, 2003

(30) Foreign Application Priority Data
Aug. 7, 2002 (JP) 198785/2002

(51) Int. Cl. H04N 5/225

(52) U.S. Cl. 348/231.99

(57) ABSTRACT

A slot for removably receiving a flexible disk is provided on the main body of the digital video camera to allow the user to use a flexible disk as the storage medium for storing an image data obtained by the camera.

### BACKGROUND OF THE INVENTION

1. Field of the Invention

The present invention relates to a digital video camera capable of recording both still and motion picture images and has a communication means that allows the user to transmit image data obtained by the camera to external devices.

2. Description of the Related Art

Today, digital video cameras capable of digitally recording a motion picture instead of using the conventional analog system are commercially available. They are designed to digitally record a motion picture using MPEG technology. Some of them also have a photographing feature that allows the user to photograph and record a still image using JPEG technology.

Some other digital video cameras have a communication facility that allows the user to transmit a motion picture image data or still image data obtained by the camera, transmit and receive e-mail messages, and gain access to the Internet to browse web pages through a cellular phone or personal computer.

Media in tape form, such as a DVC (digital video cassette) have conventionally been used as storage media for the digital video cameras described above. However, the medium in tape form has a drawback that it is inconvenient to the user, because it does not provide a random access capability and takes time, for example, in searching out the beginning of motion picture image data, etc. stored on the medium. In addition, the complicated structure of a driving section of a tape drive results in high cost and increased power consumption for the digital video camera.

Still other commercially available digital video cameras allow the user to use an attachable/detachable storage medium of semiconductor memory in conjunction with the storage medium in tape form, in order to improve compatibility with personal computers. However, the semiconductor memory is costly, so that it is difficult for the user to freely distribute copies of the image data stored in the semiconductor memory to others, or make a plurality of copies for oneself.

### SUMMARY OF THE INVENTION

The present invention has been developed in recognition of the circumstance described above, and it is an object of the present invention to eliminate the problems arising from the storage media described above and enhance the merchantability of the digital video camera.

A digital video camera according to the present invention comprises a camera body; an imaging means provided in the camera body capable of selectively imaging a still or motion picture image; a communication means provided in the camera body for transmitting the image data obtained by said imaging means to an external image data receiving means; and a display means provided in the camera body for displaying said image, said camera body having a slot capable of removably receiving a flexible disk for storing said image data.

Preferably, the flexible disk described above is a small magnetic medium of less than or equal to 50.8 mm (2 inches) in diameter with large capacity, such as Clik!™.

Further, the imaging means according to the present invention may further comprise a shutter button for indicating the timing of imaging, and the imaging means may be an imaging means that switches the imaging between still and motion picture images based on the duration of time for which the shutter button is pressed down.

In this case, the imaging means may be adapted to obtain a still image when the duration is less than a predetermined time period, and a motion picture when the duration is equal to or more than the predetermined time period.

The digital video camera according to the present invention has a slot capable of removably receiving a flexible disk to allow the user to use a flexible disk as the storage means for the image data obtained by the camera, so that the user may gain access to the desired image data on the storage means faster than with a digital video camera that uses a storage medium in tape form as the storage means, since the flexible disk provides a random access capability. In addition, the structure of the driving section of the disk drive is relatively simple, so that the cost of the camera may be kept down. Further, the disk drive consumes less power so that the battery of the camera may be operational for a longer period of time.

Further, the digital video camera according to the present invention may be used more freely by the user than a digital video camera that uses a semiconductor memory as the storage means, since the flexible disk is less expensive than the semiconductor memory.

In addition, the storage stability of the optical disk is confirmed only for about 20 years, whereas that of the magnetic flexible disk is proved to be nearly 100 years. Further, recordable optical disks are categorized into two types: recordable and rewritable optical disks. The recordable optical disk may be produced at a low cost, but it is not suited for use with the digital video camera described in the present application. On the other hand, the rewritable optical disk is more expensive than the magnetic flexible disk, thus it is preferable to use the magnetic flexible disk as the storage means for the digital video camera.

As described above, the problems arising from the conventional storage media are eliminated by allowing the user to use a flexible disk as the storage means so that the merchantability of the digital video camera may be enhanced.

### BRIEF DESCRIPTION OF THE DRAWINGS

FIG. 1 is an outline view of a digital video camera according to an embodiment of the present invention.

FIG. 2 is a block diagram illustrating major components of the digital video camera shown in FIG. 1.

FIG. 3A is a timing chart illustrating the timing of recording a still image based on the duration of a shutter button being pressed down.

FIG. 3B is a timing chart illustrating the timing of recording a motion picture based on the duration of a shutter button being pressed down.

### DESCRIPTION OF THE PREFERRED EMBODIMENTS

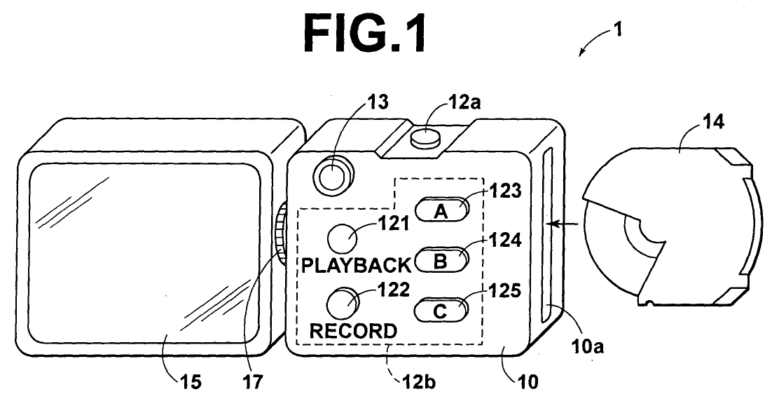

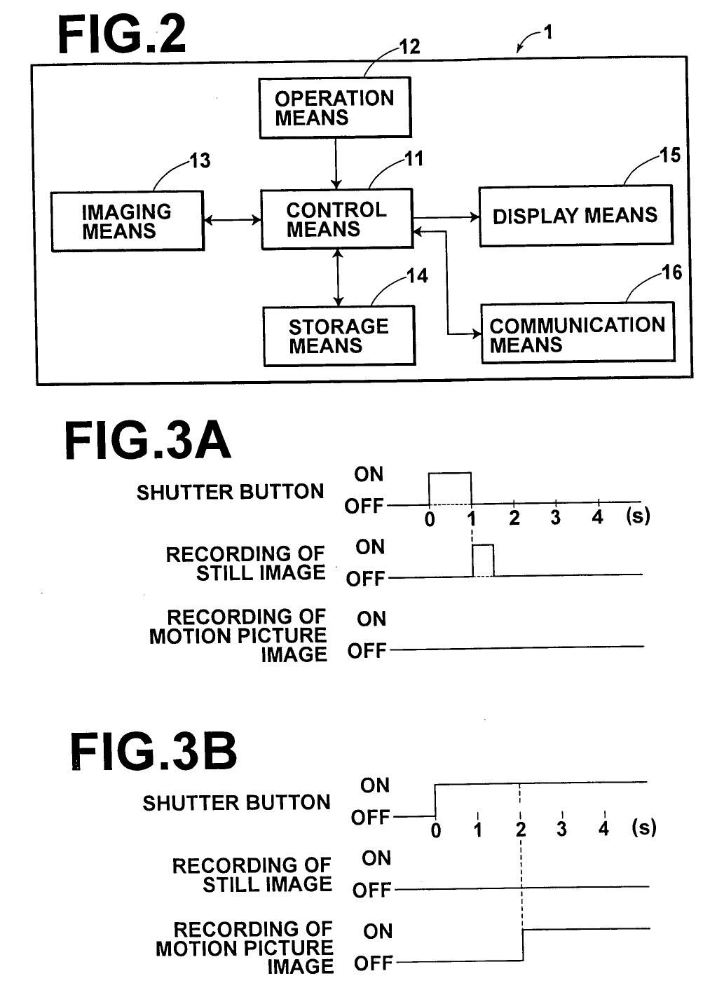

Hereinafter, preferred embodiments of the present invention will be described in detail with reference to the accompanying drawings. FIG. 1 is a view showing the outer appearance of a digital video camera according to an embodiment of the present invention. FIG. 2 is a block diagram illustrating the major components of the digital video camera shown in FIG. 1.

The digital video camera 1 according to this embodiment comprises a CCD (imaging means) 13 for imaging a still or motion picture image, a slot 10a for receiving a attachable/detachable flexible disk (storage means) 14 that stores still or motion picture image data obtained by the imaging means, an operation means 12 comprising a shutter button 12a and a simplified operation switch group 12b, a communication means 16 for establishing communication with an external device, CPU (control means) 11 for centrally controlling respective sections of the digital video camera 1, and the like, all housed in a main body 10.

A monitor 15 is rotatably connected to the main body 10 by a connecting member 17. The shutter button 12a is disposed in the center of the upper face of the main body 10. The CCD 13 and the simplified operation switch group 12b are disposed on the front face (main operational face) of the main body 10. The connecting member 17 for connecting the monitor 15 to the main body 10 may be a hinged structure that allows the monitor to be folded freely, or a universal joint structure that allows the monitor to be rotated freely three dimensionally.

Construction of the digital video camera in the aforementioned manner provides the user with substantially the same operability when the CCD is directed toward the user or the opposite side, since the shutter button 12a is disposed in the center of the upper face of the main body 10. In addition, the monitor 15 is rotatably connected to the main body 10, so that the monitor 15 may be placed in a position which is easily viewable to the user regardless of the direction of the main body 10. Furthermore, the monitor 15 may display the image most suitably in response to the operating conditions of the digital video camera by inverting the image upside down on the monitor 15 when the surface of the display becomes orthogonal to the main body 10 so that the upper side of the image on the monitor 15 always coincides with that of the main body 10 regardless of its position.

The slot 10a has therein a spindle motor for rotating the medium of the flexible disk (storage means) 14, a read/write head for reading and writing data from and to the medium, and the like.

The communication means 16 has communication functions which are equivalent to those of a cellular phone (or PHS), and the digital video camera of the present invention may be used as a telephone with the use of a speaker and microphone (not shown). In addition, it may transmit and receive image data, etc. through a packet transmission facility. Further, it may display the current geographical position of the digital video camera 1 or the user of the digital video camera 1 by providing a GPS function.

The operation means 12 comprises the shutter button 12a, the simplified operation switch group 12b, and a detailed operation switch group (not shown) comprising a number of buttons similar to the push buttons of a cellular phone.

The detailed operation switch group comprises a number of buttons having various functions required for the operation of the digital video camera 1, including a destination address setting function for the transmission of the image data obtained by the camera, etc., and a management function for the image data obtained by the camera, and is disposed at a place other than on the main operational face.

The simplified operation switch group 12b comprises five buttons, each having a function which is used more frequently than others in the operation of the digital video camera 1. The simplified operation switch group according to this embodiment comprises a playback switch 121, recording switch 122, and three destination switches 123, 124, and 125. Each of the three destination switches 123, 124, and 125 is provided to allow the user to invoke each of the three destinations that have been preset by the detailed operation switch group. Providing the simplified operation switch group 12b comprising less than or equal to five buttons in this manner allows the user who is not familiar with machine operation to operate the digital video camera 1 with ease. Further, it may be possible to allocate a plurality of functions to a single button. For example, pressing down the recording switch 122 on and off three times may turn off the digital video camera 1.

The storage means 14 uses Clik!™, which is a flexible disk with a small diameter.

The digital video camera according to this embodiment uses a flexible disk, such as Clik!™ as the storage means 14, so that the user may gain access to the desired image data on the storage medium faster than with a digital video camera that uses a storage medium in tape form as the storage means, since the flexible disk provides a random access capability. In addition, the structure of the driving section of the disk drive is relatively simple so that the cost of the camera may be kept down. Further, the disk drive consumes less power so that the battery of the camera may be operational for a longer period of time.

Further, the digital video camera according to this embodiment may be used more freely by the user than a digital video camera that uses a semiconductor memory as the storage means, since the flexible disk is less expensive than the semiconductor memory.

As described above, the problems arising from the conventional storage media are eliminated by allowing the user to use a flexible disk as the storage means, so that the merchantability of the digital video camera may be enhanced.

Next, the operation of the digital video camera constructed in the aforementioned manner will be described hereinafter. The digital video camera 1 according to this embodiment switches imaging between still and motion picture images based on the duration of time for which the shutter button 12a is pressed down. More specifically, the digital video camera according to this embodiment obtains a still image when the shutter button 12a is pressed down for less than 2 seconds, and a motion picture when it is pressed down for 2 seconds or more. The threshold time for the switchover from imaging of a still image to imaging of a motion picture image, however, is not limited to 2 seconds. FIG. 3 is a timing chart illustrating the timing of recording a still or motion picture image based on the duration of time for which the shutter button is pressed down.

As shown in FIG. 3A, if the shutter button 12a is released within a time of less than 2 seconds, the CPU 11 drives the CCD 13 to obtain a still image and store it on the storage means 14 at the time when the shutter button 12a is released.

As shown in FIG. 3B, when the time elapsed from the start of pressing down of the shutter button is equal to or more than 2 seconds, the CPU drives the CCD 13 to start obtaining motion picture image data and store it on the storage means 14 from the time when the time elapsed from the start of pressing down of the shutter button is equal to 2 seconds. The digital video camera 1 may be adapted to stop recording the motion picture when the shutter button 12a is released, or when a stop button (not shown) is pressed down after the shutter button 12a is released.

The aforementioned design causes a time lag (threshold time of 2 seconds) between the pressing down of the shutter button 12a and the start of recording a motion picture. This time lag may be eliminated by the adoption of the following design.

A buffer having sufficient capacity for storing the motion picture image data obtained during the threshold time or a longer time period (for 2 seconds or more in this embodiment) for determining whether to obtain a still or motion picture image data with respect to the shutter button 12a being pressed down is provided between the CCD 13 and the storage means 14, and the motion picture data obtained by the CCD 13 is stored on the storage means 14 through the buffer.

The CPU 11 is adapted to drive CCD 13 to initiate imaging a motion picture image and store the data obtained by the CCD 13 in the buffer from the time when the shutter button 12a is pressed down.

If the shutter button 12a is released within a time of less than 2 seconds, then the CPU 11 controls the CCD 13 to stop imaging the motion picture and store the data of the first frame of the image data stored in the buffer onto the storage means 14 as still image data.

When the time elapsed from the start of pressing down of the shutter button 12a is equal to or more than 2 seconds, the CPU 11 controls the CCD 13 to continue imaging the motion picture image and store the data stored in the buffer onto the storage means 14 sequentially from the first frame as motion picture image data.

By designing the digital video camera 1 in this manner, the time lag between the activation of the shutter button 12a and the initiation of the recording may be eliminated.

By providing the single shutter button 12a with the function that allows selective recording of a still or motion picture image as described above, the user may record a still or motion picture image without worrying about the selection of a shutter button for still or motion picture image, thereby user friendliness of the digital video camera 1 may be enhanced.

What is claimed is:

1. A digital video camera comprising:
a camera body;
an imaging means provided in the camera body capable of selectively imaging a still or motion picture image;
a communication means provided in the camera body for transmitting image data obtained by said imaging means to an external image data receiving means; and
a display means provided on the camera body for displaying said image, wherein
said camera body has a slot capable of removably receiving a flexible disk for storing said image data.

2. A digital video camera according to claim 1, wherein said removable flexible disk has a diameter of less than or equal to 50.8 mm (2 inches).

3. A digital video camera according to claim 1, wherein said camera further comprises a shutter button disposed in the center of the upper face of said camera body.

4. A digital video camera according to claim 3, wherein said shutter button is adapted for use to indicate the timing of imaging to said imaging means, and said imaging means switches said imaging between still and motion picture images based on the duration of time for which said shutter button is pressed down.

5. A digital video camera according to claim 4, wherein said imaging means obtains a still image when said duration is less than a predetermined time period, and a motion picture when said duration is equal to or more than said predetermined time period.
